(19) United States
(12) Patent Application Publication
(10) Pub. No.: US 2011/0316273 A1
(43) Pub. Date: Dec. 29, 2011

(54) DUAL SEAL TUBE FITTING

(75) Inventor: Sam T. Hong, Sparks, NV (US)

(73) Assignee: HAWS CORPORATION, Sparks, NV (US)

(21) Appl. No.: 13/165,641

(22) Filed: Jun. 21, 2011

Related U.S. Application Data
(60) Provisional application No. 61/358,997, filed on Jun. 28, 2010.

(51) Int. Cl. F16L 17/00

(52) U.S. Cl. 285/344

(57) ABSTRACT

A dual seal tube fitting is provided for quick and easy, substantially leak-free coupling with plastic tubing or the like in a water supply application, such as in a drinking fountain or the like. A reinforcing metal sleeve is slidably received into the end of a length of tubing which is then slidably received into a central bore of a fitting body having a resilient seal ring seated therein for sealingly engaging an outer diameter surface of the tubing. A compression ring is slidably received onto the tubing in a position over a portion of the internal sleeve therein, and is compressibly retained between the tubing and a fitting body seal face by a compression nut threaded onto the fitting body. The resilient seal ring thus provides a primary seal preventing leakage between the tubing and fitting body, whereas the compression ring provides a secondary seal.

### BACKGROUND OF THE INVENTION

This invention relates generally to improvements in fluid couplings and fittings of the type used to sealingly interconnect a length of tubing with other components in a fluid-carrying application such as in a drinking fountain or the like. More particularly, the improved tube fitting of the present invention includes dual seal components which are axially spaced from each other to provide redundant or backstop sealing capability in combination with secure tubing support and retention. The entire tube fitting is designed for quick and easy assembly to provide safe and secure, substantially leak-free operation.

Tubing connections or couplings are widely used for connecting a fluid or liquid-carrying length of tubing to a variety of structures, such as in a water drinking fountain and the like. Sealing of the tube coupling is of paramount importance to guard against fluid (water) leakage and potential property damage over an extended period of time, and when subjected to a variety of temperature and other environmental conditions.

In the past, various sealing approaches have been taken to prevent water or other fluid leakage in a tube coupling. For example, resilient seal rings are known in the art for use in sealing between an outer diameter surface of a length of tubing, and a tube coupling or body into which the end of the tubing length is inserted. Similarly, compression-type seals are also known in the art wherein a compressible ring having tapered surfaces is installed onto the tubing and then compressed axially and radially against a tapered surface on a tubing body by means of a threaded nut. Both types of seals, however, are generally unsuited for use with a lightweight and somewhat resilient length of plastic tubing. Other tubing seal arrangements suitable for use with lightweight plastic tubing are typified by push-in, collet-type structures as shown and described, for example, in U.S. Pat. Nos. 6,056,326 and 7,686,349, which are incorporated by reference herein.

The present invention pertains to the provision of dual or redundant seal components in a single tube fitting assembly using a relatively lightweight and resilient length of tubing, such as plastic tubing or the like. The invention resides in internal reinforcement of the end of the lightweight tubing to accommodate redundant safe and secure sealing in a tube fitting that is adapted for quick and easy assembly.

### SUMMARY OF THE INVENTION

In accordance with the invention, a dual seal tube fitting is provided for quick and easy, substantially leak-free coupling with lightweight plastic tubing or the like in a water or other fluid supply application, such as in a drinking fountain or the like. The end of the tubing is internally reinforced by a metal sleeve slidably received therein, followed by tubing insertion slidably into a central bore of a fitting body carrying a resilient seal ring for sealingly engaging an outer diameter surface of the tubing. A compression ring or ferrule slidably received onto the tubing in a position over a portion of the internal reinforcing sleeve is compressibly retained between the tubing and a tapered fitting body seal face by a compression nut threaded onto the fitting body. The assembled tube fitting thus includes a primary seal provided by the resilient seal ring and a secondary or backstop seal provided by the compression ring.

In one preferred form, the fitting body and the internal reinforcing metal sleeve are both formed from a sturdy material such as stainless steel. The compression ring and nut are both formed from a softer material such as brass or the like. The resilient seal ring is retained between an outer diameter surface of the tubing and the fitting body to provide the primary seal resistant to vibration and/or other abusive conditions. The compression ring provides a backstop or secondary seal which virtually eliminates risk of leakage in the event that the primary seal ring becomes compromised or damaged.

Other features and advantages of the present invention will become more apparent from the following detailed description taken in conjunction with the accompanying drawings which illustrate, by way of example, the principles of the invention.

### BRIEF DESCRIPTION OF THE DRAWINGS

The accompanying drawings illustrate the invention. In such drawings:

FIG. 1 is a perspective view showing an assembled dual seal tube fitting embodying the novel features of the invention;

FIG. 2 is an exploded perspective view of the dual seal tube fitting depicted in FIG. 1;

FIG. 3 is a perspective view, shown partially in vertical section, showing partial assembly of the dual seal tube fitting; and

FIG. 4 is a perspective view, shown partially in vertical section, depicting the completed dual seal tube fitting assembly.

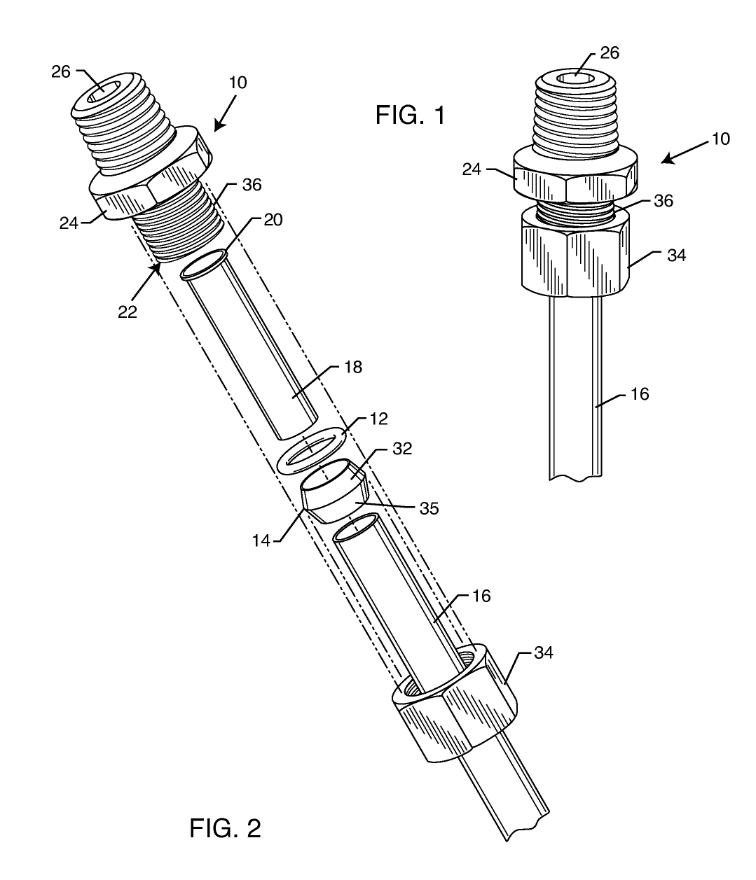

### DETAILED DESCRIPTION OF THE PREFERRED EMBODIMENTS

As shown in the exemplary drawings, an improved dual seal tube fitting referred to generally by the reference numeral 10 includes a primary seal or seal member in the form of a resilient seal ring 12, such as an O-ring or the like, in combination with a secondary or backstop seal or seal member in the form of a metal compression ring or ferrule 14. The tube fitting 10 is designed for quick and easy, substantially intuitive assembly, while providing redundant seal structures to safeguard against fluid leakage during use. As one example, the tube fitting 10 is envisioned for use in a drinking fountain or the like to carry potable water to a dispensing or bubbler head (not shown) or the like. The provision of redundant seal structures virtually assures against water leakage and resultant potential property damage.

The tube fitting 10 of the present invention is particularly designed for use with a length of fluid-carrying (water) tubing 16 formed from a lightweight and at least somewhat resilient material such as extruded plastic tubing or the like used in a potable water application such as a drinking fountain and the like. The tube fitting 10 is used for sealed, substantially leak-free connection to an end of the tubing 16 for suitable connection to other system components, such as to a drinking fountain dispense head (not shown), or to another length of tubing, etc. In accordance with an important feature of this invention, the end of the tubing 16 is structurally reinforced by slide-fit insertion of a relatively rigid and preferably metal insert sleeve 18 which extends a short axial distance within the tubing 16 sufficient to provide a rigid backstop support for the dual seal components 12,14 as will be described in more detail herein.

The insert sleeve 18 is shown best in FIGS. 2-4. As shown, the insert sleeve 18 comprises a hollow tubular component having an axial length of at least about 1-2 inches, and an end flange 20 having a radial size and shape for nested fit against and over the end of the tubing 16 preferably without projecting radially beyond the outer diameter surface of the tubing 16. In a preferred form, the insert sleeve 18 is formed from a sturdy metal material compatible with drinking water and the like, such as stainless steel 304 or the like, and has a radial wall thickness sufficient to provide a sturdy backstop support for the assembled fitting 10 including the resilient seal ring 12 and the compression ring or ferrule 14.

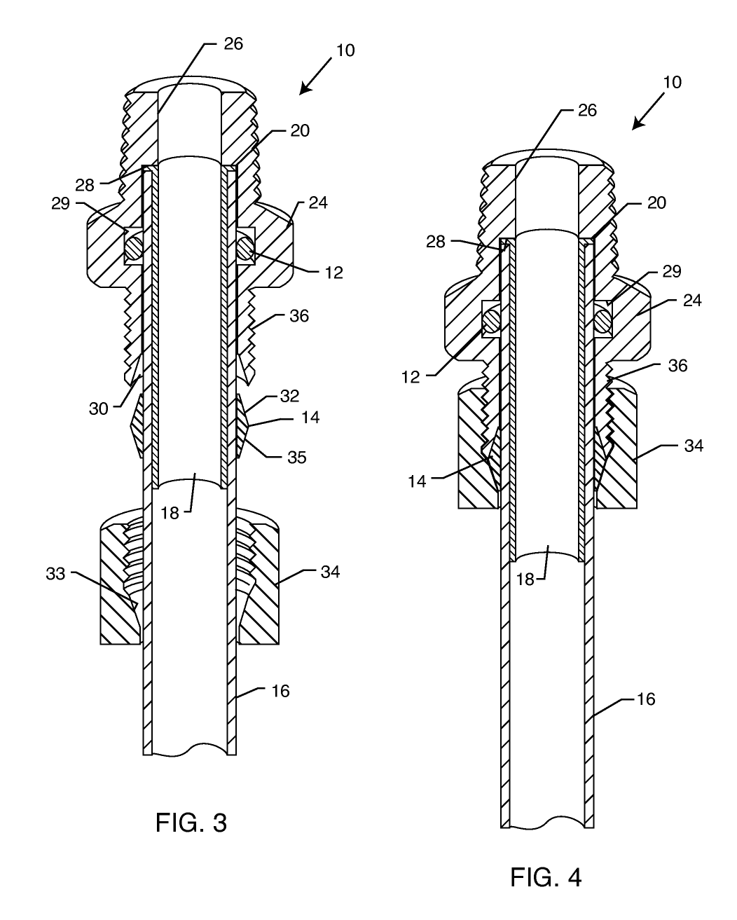

The tubing 16 with slidably fitted insert sleeve 18 are sized and shaped for relatively quick and easy slide-fit reception into an open end 22 of a fitting body 24, as shown best in FIGS. 2-4. This fitting body 24 defines a central bore 26 formed therethrough, extending from the open end 22 with a first diametric size sufficient to receive and support the end of the tubing 16. An internal shoulder 28 (FIGS. 3-4) formed within the fitting body 24 along the length of the bore 26 therein provides a step-down for engaging the end of the tubing 16 and/or the flange 20 of the insert sleeve 18, with the bore 26 continuing with a smaller diametric size to the opposite end of the fitting body 24.

The resilient seal ring 12 is captured within a radially enlarged groove 29 defined by the fitting body 24 at a location axially between the open end 22 and the step-down shoulder 28. The seal ring 12 is sized and shaped to engage an outer diameter surface of the slidably fitted tubing 16 in a compressive manner acting between the tubing 16 and a radially inwardly presented surface of the groove 29 to provide an effective primary seal between the fitting body 24 and the tubing 16. Importantly, the axial length of the insert sleeve 18 is sufficient to extend from the end of the tubing 16 beyond the seal ring 12 to effectively rigidify the lightweight tubing 16 against the seal ring 12 for achieving a high quality fluid seal therewith.

The open end 22 of the fitting body 24 defines an axially and radially tapered surface 30 circumscribing the central bore 26. This tapered surface 30 is adapted to receive a similarly tapered surface 32 of the compression ring or ferrule 14 carried on the tubing 16. A compression nut 34 is also carried on the tubing 16 is a position for quick and easy thread-on engagement with male threads 36 formed on the fitting body 24 about the open end 22 thereof. Advanced thread-on engagement of the compression nut 34 with the fitting body threads 36 effectively draws a tapered surface 33 (FIG. 3) within the nut 34 into engagement with an aft-end tapered surface 35 (FIG. 2-3) on the compression ring 14, to position the compression ring 14 axially on the tubing 16, and then to compress the compression ring or ferrule 14 axially and radially against the tubing 16 with the interengaging tapered surfaces 30 and 32 providing the secondary or backstop seal (as viewed in FIG. 4). Importantly, the insert sleeve 18 has an axial length sufficient to extend at least a short distance beyond the compression ring or ferrule 14 to effectively rigidify the lightweight tubing 16 in this area so that a high quality backstop seal is formed.

In the preferred form, the fitting body 24 is also constructed from a material compatible with potable drinking water or the like, such as stainless steel 304 or the like. The compression ring or ferrule 14 and the compression nut 34 are formed from a slightly softer metal material, such as brass-based material or the like. In the most preferred form, the compression ring 14 is formed from a lead-free brass material.

In use, the assembled dual seal tube fitting 10 of the present invention functions to provide redundant seals which effectively safeguard against undesired fluid leakage. The primary seal provided by the seal ring 12 is beneficially resistant to vibration and abusive conditions such as weather conditions including temperature variations and the like. The compression nut 34 securely holds the tubing 16 in sealed engagement with the seal ring 12. However, in the unlikely event that the seal ring 12 becomes compromised or damaged in any way, the compression ring or ferrule 14 provides an effective secondary or backstop seal. Accordingly, the dual seal tube fitting 10 of the present invention reduces the potential for fluid leakage from the assembled fitting to essentially zero.

A variety of modifications and improvements in and to the dual seal tube fitting of the present invention will be apparent to those persons skilled in the art. For example, persons skilled in the art will recognize and appreciate that the fitting body may be adapted for different fluid coupling applications, different thread sizes, and different geometries including but not limited to the illustrative straight-style fitting as well as elbow fittings, tee-shaped fittings, and the like. Accordingly, no limitation on the invention is intended by way of the foregoing description and accompanying drawings, except as set forth in the appended claims.

What is claimed is:

1. A sealed coupling for attachment to the end of a length of resilient tubing, said sealed coupling comprising:
an insert sleeve constructed from a relatively rigid material and having a size and shape for insertion into the end of the length of resilient tubing;
a fitting body having an open end sized for slide-fit reception of the end of the length of resilient tubing with said insert sleeve received therein; and
at least one seal member captured between said fitting body and said resilient tubing for sealing therebetween, said seal member engaging said resilient tubing on an outer surface thereof reinforced by said insert sleeve.

2. The sealed coupling of claim 1 wherein said seal member comprises a primary seal member, and further comprising a secondary seal member captured between said fitting body and said resilient tubing for sealing therebetween, said secondary seal member engaging said resilient tubing on an outer surface thereof reinforced by said insert sleeve.

3. The sealed coupling of claim 2 wherein said primary seal member comprises a resilient seal ring, and wherein said secondary seal member comprises a compression ring in combination with tapered surfaces formed respectively on said fitting body and on a compression nut for threaded coupling with said fitting body.

4. The sealed coupling of claim 1 wherein said insert sleeve has a flange formed on one end thereof, said flange projecting radially outwardly a short distance less than the thickness of the resilient tubing, and further wherein said fitting body has an internal shoulder and an internal groove formed therein, the end of the length of resilient tubing with said insert sleeve fitted therein being slide-fit receivable into said fitting body with said insert sleeve flange supported against said internal shoulder, and said seal member comprising a resilient seal ring received into said internal groove for sealing between said fitting body and the outer surface of the resilient tubing.

5. The sealed coupling of claim 1 wherein said insert sleeve is formed from a metal material.

6. The sealed coupling of claim 1 wherein said fitting body has an internal shoulder formed therein, and further includes an internal tapered surface at an aft-end thereof for slidably receiving the end of the length of resilient tubing, said seal member comprising a compression ring slidably fitted onto the resilient tubing and including an external tapered surface for matingly engaging said fitting body tapered surface, and further comprising a compression nut for threaded coupling with said aft-end of said fitting body with said compression ring therebetween for matingly engaging said tapered surfaces of said fitting body and said compression ring.

7. The sealed coupling of claim 6 wherein said compression ring is formed from a brass-based material.

8. The sealed coupling of claim 1 wherein said fitting body is formed from a metal material compatible with contacting potable drinking water.

9. The sealed coupling of claim 1 wherein said insert sleeve has a length of at least about 1-2 inches.

10. A sealed coupling for attachment to the end of a length of resilient tubing, said sealed coupling comprising:
an insert sleeve constructed from a relatively rigid material and having a size and shape for insertion into the end of the length of resilient tubing;
a fitting body having an open end sized for slide-fit reception of the end of the length of resilient tubing with said insert sleeve received therein;
said fitting body having an internal groove formed therein, and an internal tapered surface formed at an aft-end thereof for slidably receiving the end of the length of resilient tubing;
a primary seal member comprising a seal ring captured within said internal groove and sealing engaging said fitting body and an outer surface on the resilient tubing to seal there between;
a secondary seal member comprising a compression ring having a size and shape for slide-fit reception onto the resilient tubing and including an outer tapered surface for matingly engaging said inner tapered surface on said fitting body aft-end; and
a compression nut threadably connected onto said fitting body aft-end for drawing said inner and outer tapered surfaces of said fitting body and said compression ring into sealing engagement;
said primary and secondary seal members both engaging the resilient tubing on an outer surface thereof reinforced by said insert sleeve.

11. The sealed coupling of claim 10 wherein said insert sleeve has a flange formed on one end thereof, said flange projecting radially outwardly a short distance less than the thickness of the resilient tubing, and further wherein said fitting body has an internal shoulder formed therein at a position with said groove interposed between said internal shoulder and said aft-end of said fitting body, the end of the length of resilient tubing with said insert sleeve fitted therein being slide-fit receivable into said fitting body with said insert sleeve flange supported against said internal shoulder.

12. The sealed coupling of claim 10 wherein said insert sleeve is formed from a metal material.

13. The sealed coupling of claim 10 wherein said compression ring is formed from a brass-based material.

14. The sealed coupling of claim 10 wherein said fitting body is formed from a metal material compatible with contacting potable drinking water.

15. The sealed coupling of claim 10 wherein said insert sleeve has a length of at least about 1-2 inches.
